(19) United States
(12) Patent Application Publication
(10) Pub. No.: US 2007/0224436 A1
(43) Pub. Date: Sep. 27, 2007

(54) Film forming composition

(75) Inventor: Hidetoshi Hiraoka, Shizuoka (JP)

Correspondence Address: SUGHRUE-265550, 2100 PENNSYLVANIA AVE. NW, WASHINGTON, DC, 20037-3213, US

(73) Assignee: FUJIFILM Corporation, Minato-ku (JP)

(21) Appl. No.: 11/723,852

(22) Filed: Mar. 22, 2007

(30) Foreign Application Priority Data
Mar. 22, 2006 (JP) 2006-079309

(51) Int. Cl. B32B 27/32

(52) U.S. Cl. 428/500; 106/122; 526/285; 526/280; 428/521; 428/523

(57) ABSTRACT

A film forming composition comprises a compound having a cage structure and a thermally decomposable compound, an insulating film is formed by using the film forming composition and an electronic device comprises the insulating film.

### BACKGROUND OF THE INVENTION

1. Field of the Invention

The present invention relates to a film forming composition, more specifically, an insulating film forming composition to be used for electronic devices and excellent in film properties such as dielectric constant and mechanical strength. The invention also pertains to an insulating film obtained using the composition and electronic devices having the insulating film.

2. Description of the Related Art

In recent years, with the progress of high integration, multifunction and high performance in the field of electronic materials, circuit resistance and condenser capacity between interconnects have increased and have caused an increase in electric power consumption and delay time. Particularly, the increase in delay time becomes a large factor for reducing the signal speed of devices and generating crosstalk. Reduction of parasitic resistance and parasitic capacity are therefore required in order to reduce this delay time, thereby attaining speed-up of devices. As one of the concrete measures for reducing this parasitic capacity, an attempt has been made to cover the periphery of an interconnect with a low dielectric interlayer insulating film. The interlayer insulating film is expected to have superior heat resistance in the thin film formation step when a printed circuit board is manufactured or in post steps such as chip connection and pin attachment and also chemical resistance in the wet process. In addition, a low resistance Cu interconnect has been introduced in recent years instead of an Al interconnect, and accompanied by this, CMP (chemical mechanical polishing) has been employed commonly for planarization of the film surface. Accordingly, an insulating film having high mechanical strength and capable of withstanding this CMP step is required.

As a highly heat-resistant interlayer insulating film, polybenzoxazole, polyimide, polyarylene (ether) and the like films have been disclosed for long years. There is however a demand for the development of materials having a lower dielectric constant in order to realize a high speed device. Introduction of a hetero atom such as oxygen, nitrogen or sulfur or an aromatic hydrocarbon unit in the molecule of a polymer as the above-described materials, however, increases a dielectric constant owing to high molar polarization, causes a time-dependent increase in the dielectric constant owing to moisture absorption, or causes a trouble impairing reliability of an electronic device so that these materials must be improved.

A polymer composed of a saturated hydrocarbon has advantageously a lower dielectric constant because it has smaller molar polarization than a polymer composed of a hetero-atom-containing unit or aromatic hydrocarbon unit. For example, a hydrocarbon such as polyethylene having high flexibility has however only insufficient heat resistance and therefore cannot be used for electronic devices.

Polymers having a saturated hydrocarbon having a rigid cage structure such as adamantane or diamantane introduced in their molecules are disclosed in JP-A-2000-100808, JP-A-2001-2899 and JP-A-2001-2900 (the term “JP-A” as used herein means an “unexamined published Japanese patent application”). Adamantane or diamantane is a preferable unit because it has a diamondoid structure and exhibits high heat resistance and low dielectric constant. The solubility of these polymers in a solvent is however too low to form a thin film or the dielectric constant of them inevitably increases owing to the influence of a linking group of the cage structure. Their improvement is therefore required.

### SUMMARY OF THE INVENTION

The invention relates to a film forming composition for overcoming the above-described problems. More specifically, the invention relates to an insulating film forming composition used for electronic devices and excellent in film properties such as dielectric constant and mechanical strength. (An “insulating film” is also referred to as a “dielectric film” or a “dielectric insulating film”, and these terms are not substantially distinguished.) The invention further pertains to an insulating film available using the composition and an electronic device having the insulating film.

The present inventors have found that the above-described problems can be overcome by the following constitution.

<1> A film forming composition comprising;

a compound having a cage structure; and

a thermally decomposable compound.

<2> The film forming composition as described in <1>,

wherein the thermally decomposable compound is at least one compound selected from compounds having a structure represented by any one of formulas (A-1) to (A-3) and compounds having a composite structure of formulas (A-2) and (A-3):

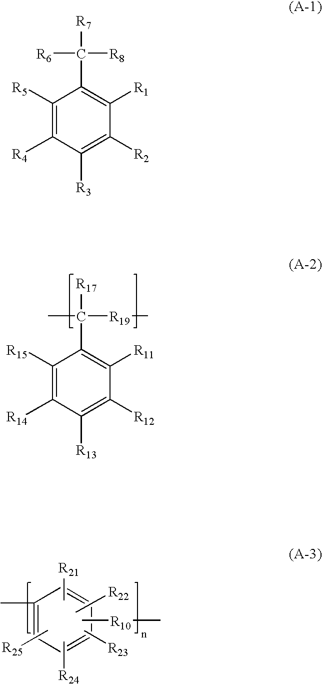

wherein R₁ to R₆, R₈, R₁₁ to R₁₅ and R₂₁ to R₂₅ each independently represents a hydrogen atom or a hydrocarbon group;

R₇ and R₁₇ each independently represents a hydrocarbon group containing an oxygen atom; and

R₁₉ and R₁₀ each independently represents an alkylene group.

<3> The film forming composition as described in <1>,

wherein the cage structure is selected from adamantane, biadamantane, diamantane, triamantane, and tetramantane.

<4> The film forming composition as described in <1>,

wherein the compound having the cage structure is a polymer of a monomer having a cage structure.

<5> The film forming composition as described in <4>,

wherein the monomer having the cage structure has a carbon-carbon double bond or carbon-carbon triple bond.

<6> The film forming composition as described in <4>,

wherein the monomer having the cage structure is selected from the group consisting of monomers represented by formulas (I) to (VI):

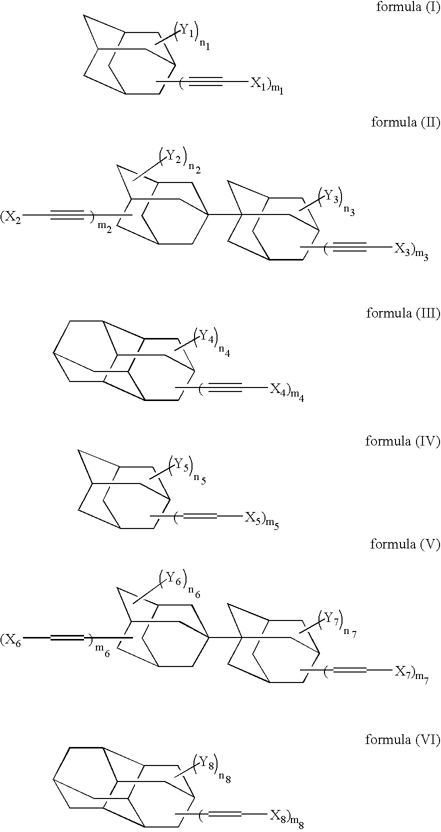

wherein X₁ to X₈ each independently represents a hydrogen atom, alkyl group, alkenyl group, alkynyl group, aryl group, silyl group, acyl group, alkoxycarbonyl group or carbamoyl group, and when a plurality of each of X₁s to X₈s are present, they may be the same or different;

Y₁ to Y₈ each independently represents a halogen atom, alkyl group, aryl group or silyl group, and when a plurality of each of Y₁s to Y₈s are present, they may be the same or different;

m₁ and m₅ each independently represents an integer of from 1 to 16;

n₁ and n₅ each independently represents an integer of from 0 to 15;

m₂, m₃, m₆ and m₇ each independently represents an integer of from 1 to 15;

n₂, n₃, n₆ and n₇ each independently represents an integer of from 0 to 14;

m₄ and m₈ each independently represents an integer of from 1 to 20; and

n₄ and n₈ each independently represents an integer of from 0 to 19.

<7> The film forming composition as described in <4>, which is obtained by polymerizing the monomer having the cage structure in the presence of a transition metal catalyst or a radical initiator.

<8> The film forming composition as described in <1>,

wherein the compound having the cage structure has a solubility of 3 mass % (in this specification, mass ration is equal to weight ration) or greater in cyclohexanone or anisole at 25° C.

<9> The film forming composition as described in <1>, further comprising an organic solvent.

<10> An insulating film formed by using the film forming composition as described in <1>.

<11> An electronic device comprising the insulating film as described in <10>.

### DETAILED DESCRIPTION OF THE INVENTION

The present invention will hereinafter be described specifically.

### [1] Compound Having a Cage Structure

The term “cage structure” as used herein means a molecule in which a plurality of rings formed of covalent-bonded atoms define the capacity of the structure and in which all points existing inside the capacity cannot leave the capacity without passing through the rings. For example, an adamantane structure may be considered as the cage structure. Contrary to this, a single crosslink-having cyclic structure such as norbornane (bicyclo[2,2,1]heptane) cannot be considered as the cage structure because the ring of the single-crosslinked cyclic compound does not define the capacity of the compound.

The cage structure of the invention may contain either a saturated bond or unsaturated bond and may contain a hetero atom such as oxygen, nitrogen or sulfur. A saturated hydrocarbon is however preferred from the viewpoint of a low dielectric constant.

Preferred examples of the cage structure of the invention include adamantane, biadamantane, diamantane, triamantane and tetramantane, of which adamantane, biadamantane and diamantane are more preferred. Of these, biadamantane and diamantane are especially preferred, because they have a low dielectric constant.

The cage structure according to the invention may have one or more substituents. Examples of the substituents include halogen atoms (fluorine, chlorine, bromine or iodine atom), linear, branched or cyclic C₁₋₁₀ alkyl groups (such as methyl group, t-butyl group, cyclopentyl group and cyclohexyl group), C₂₋₁₀ alkenyl groups (such as vinyl group and propenyl group), C₂₋₁₀ alkynyl groups (such as ethynyl group and phenylethynyl group), C₆₋₂₀ aryl groups (such as phenyl group, 1-naphthyl group and 2-naphthyl group), C₂₋₁₀ acyl groups (such as benzoyl group), C₂₋₁₀ alkoxycarbonyl groups (such as methoxycarbonyl group), C₁₋₁₀ carbamoyl groups (such as N,N-diethylcarbamoyl group), C₆₋₂₀ aryloxy groups (such as phenoxy group), C₆₋₂₀ arylsulfonyl groups (such as phenylsulfonyl group), nitro group, cyano group, and silyl groups (such as triethoxysilyl group, methyldiethoxysilyl group and trivinylsilyl group).

In the invention, the cage structure has preferably a valence of from two to four. In this case, a group to be bound to the cage structure may be a substituent having a valence of one or more or a linking group having a valence of two or more. The cage structure has more preferably a valence of two or three, especially a valence of two. The term “valence” as used herein means the number of chemical bonds.

The cage structure in the invention may be substituted as a pendant group in the polymer (copolymer) or may become a portion of the polymer main chain, but latter is preferred. When the cage structure becomes a portion of the polymer main chain, the polymer chain is broken by the removal of the cage compound from the polymer. In this state, the cage structure may be linked directly via a single bond or by an appropriate divalent linking group. Example of the linking group include —C(R₃₁)(R₃₂)—, —C(R₃₃)═C(R₃₄)—, —C≡C—, arylene group, —CO—, —O—, —SO₂—, —N(R₃₅)—, and —Si(R₃₆)(R₃₇)—, and combination thereof. In these groups, R₃₁ to R₃₇ each independently represents a hydrogen atom, an alkyl group, an alkenyl group, an alkynyl group or an aryl group. These linking groups may be substituted by a substituent and as the substituent, the above-described ones are preferred.

Of these, —C(R₃₁)(R₃₂)—, —CH═CH—, —C≡C—, arylene group, —O—, —Si(R₃₆)(R₃₇)— and combination thereof are more preferred, with —C(R₃₁)(R₃₂)— and —CH═CH— being especially preferred in consideration of a low dielectric constant.

The insulation film of the invention is preferably free of a nitrogen atom from the standpoints of dielectric constant and moisture absorption of film, especially preferably free of a polyimide bond.

The monomer having a cage structure for use in the invention has preferably a polymerizable carbon-carbon double bond or carbon-carbon triple bond. It is more preferably a compound represented by any one of the following formulas (I) to (VI):

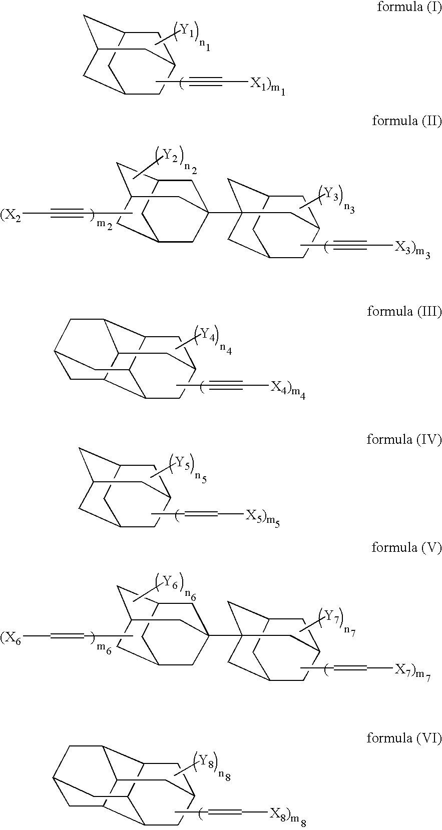

In the formulas (I) to (VI),

X₁ to X₈ each independently represents a hydrogen atom, an alkyl group (preferably C₁₋₁₀), alkenyl group (preferably C₂₋₁₀), alkynyl group (preferably C₂₋₁₀), aryl group (preferably C₆₋₂₀), silyl group (preferably C₀₋₂₀), acyl group (preferably C₂₋₁₀), alkoxycarbonyl group (preferably C₂₋₁₀), or carbamoyl group (preferably C₁₋₂₀), of which a hydrogen atom, C₁₋₁₀ alkyl group, C₆₋₂₀ aryl group, C₀₋₂₀ silyl group, C₂₋₁₀ acyl group, C₂₋₁₀ alkoxycarbonyl group, or C₁₋₂₀ carbamoyl group is preferred; a hydrogen atom or C₆₋₂₀ aryl group is more preferred; and a hydrogen atom is especially preferred. When there are a plurality of X₁s to X₈s, they may be the same or different.

Y₁ to Y₈ each independently represents a halogen atom (fluorine, chlorine, bromine or the like), an alkyl group (preferably C₁₋₁₀), aryl group (preferably C₆₋₂₀), or silyl group (preferably C₀₋₂₀), of which a substituted or unsubstituted C₁₋₁₀ alkyl or C₆₋₂₀ aryl group is more preferred and an alkyl group (such as methyl) is especially preferred. When there are a plurality of Y₁s to Y₈s, they may be the same or different.

X₁ to X₈ and Y₁ to Y₈ may each be substituted with another substituent. Examples of the substituent include halogen atoms (fluorine, chlorine, bromine or iodine atom), alkyl groups (C₁₋₂₀, preferably C₁₋₁₀ alkyl groups such as methyl, t-butyl, cyclopentyl, cyclohexyl, adamantyl, biadamantyl and diamantyl), acyl groups (C₂₋₁₀ acyl groups such as acetyl and benzoyl), aryloxy groups (C₆₋₁₀ aryloxy groups such as phenoxy), arylsulfonyl groups (C₆₋₁₀ arylsulfonyl groups such as phenylsulfonyl), nitro group, cyano group, and silyl groups (C₁₋₁₀ silyl groups such as triethoxysilyl, methyldiethoxysilyl and trivinylsilyl). As the substituent, C₁₋₅ alkyl groups are preferred, of which methyl and ethyl groups are more preferred and methyl group is most preferred.

In the above formulas, m₁ and m₅ each independently represents an integer of from 1 to 16, preferably from 1 to 4, more preferably from 1 to 3, especially preferably 2;

n₁ and n₅ each independently represents an integer of from 0 to 15, preferably from 0 to 4, more preferably 0 or 1, especially preferably 0;

m₂, m₃, m₆ and m₇ each independently represents an integer of from 1 to 15, preferably from 1 to 4, more preferably from 1 to 3, especially preferably 2;

n₂, n₃, n₆ and n₇ each independently represents an integer of from 0 to 14, preferably from 0 to 4, more preferably 0 or 1, especially preferably 0;

m₄ and m₈ each independently represents an integer of from 1 to 20, preferably from 1 to 4, more preferably from 1 to 3, especially preferably 2; and

n₄ and n₈ each independently represents an integer of from 0 to 19, preferably from 0 to 4, more preferably 0 or 1, especially preferably 0.

Specific examples of the monomer having a cage structure for use in the invention will next be shown, but the present invention is not limited thereto.

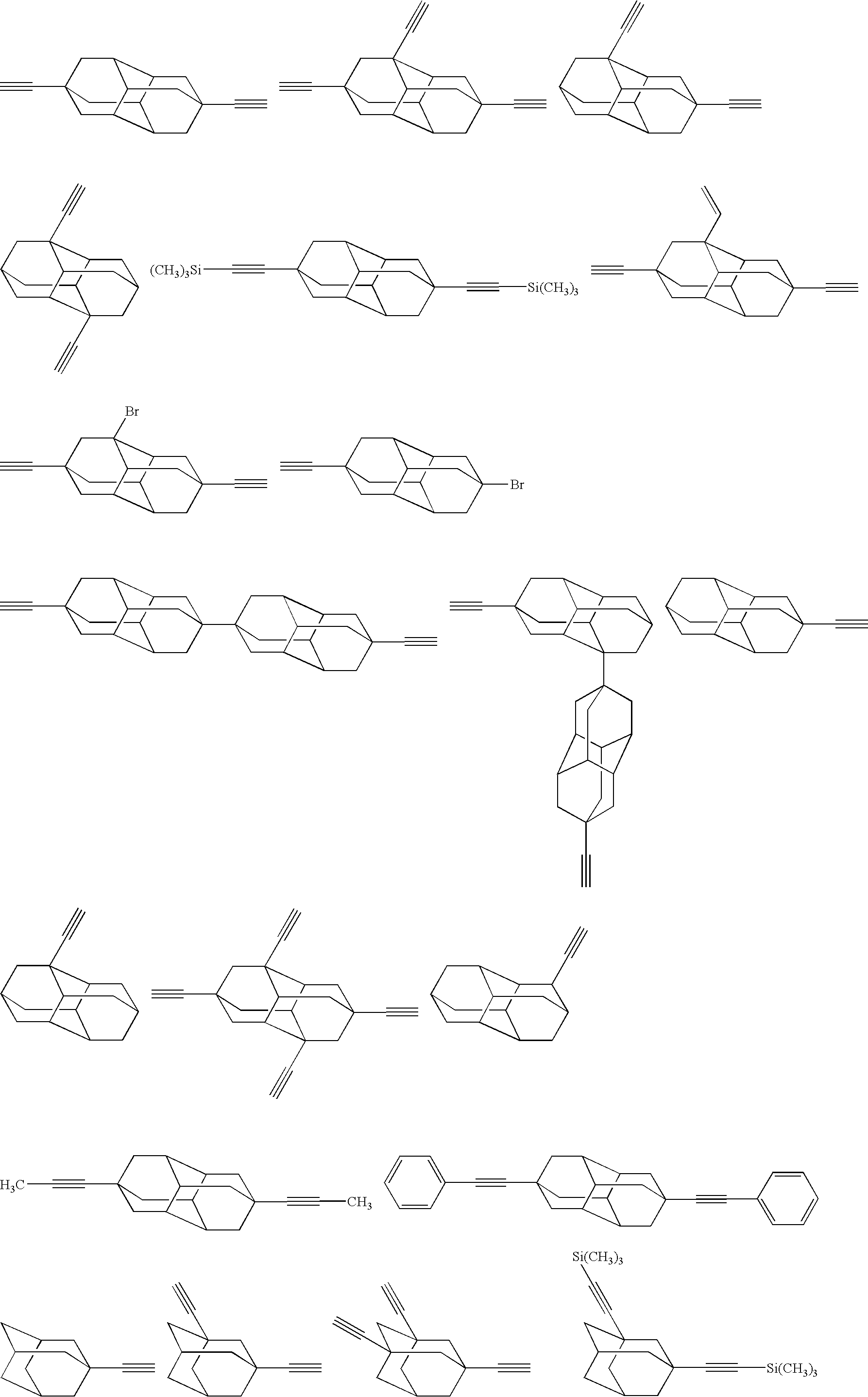

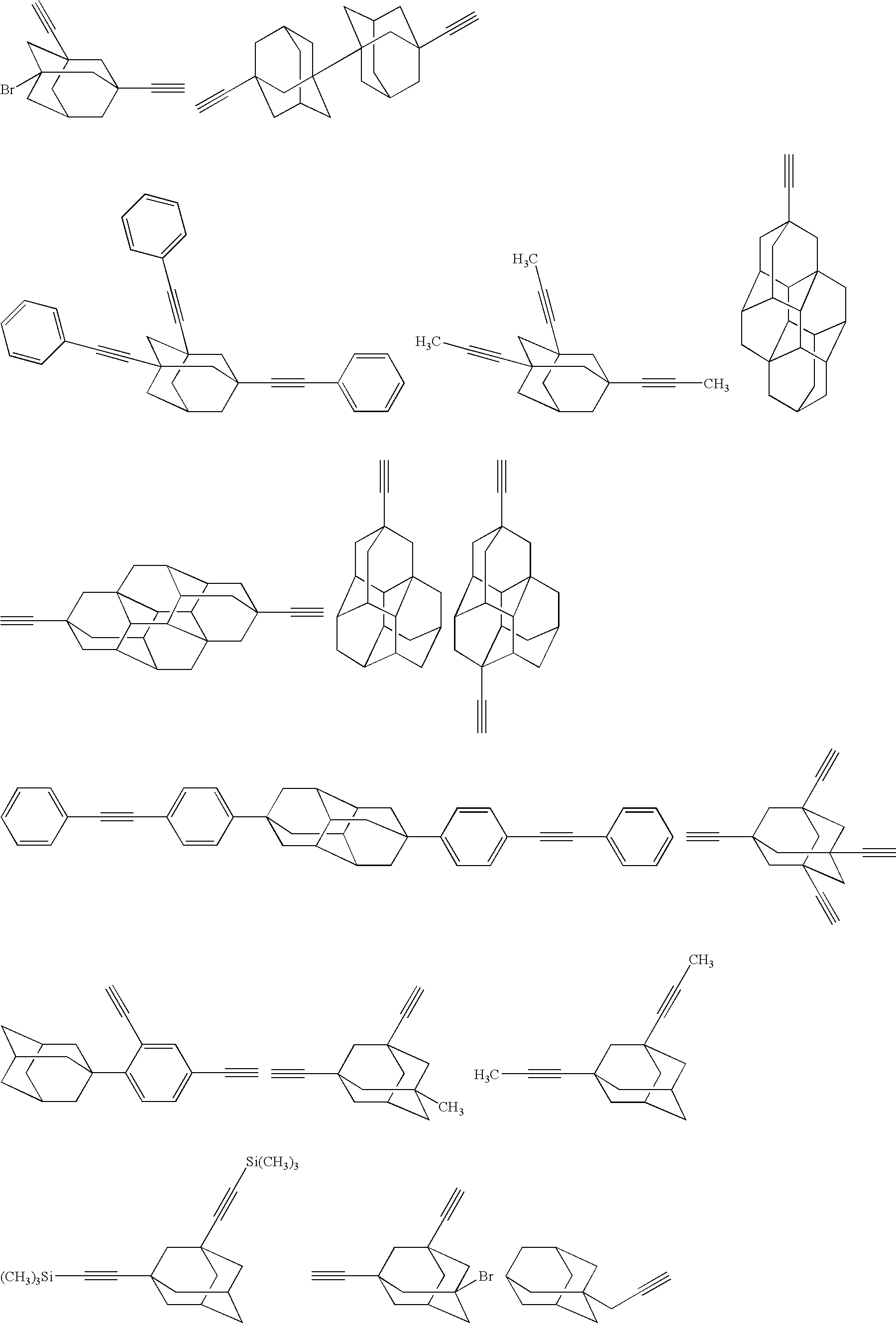

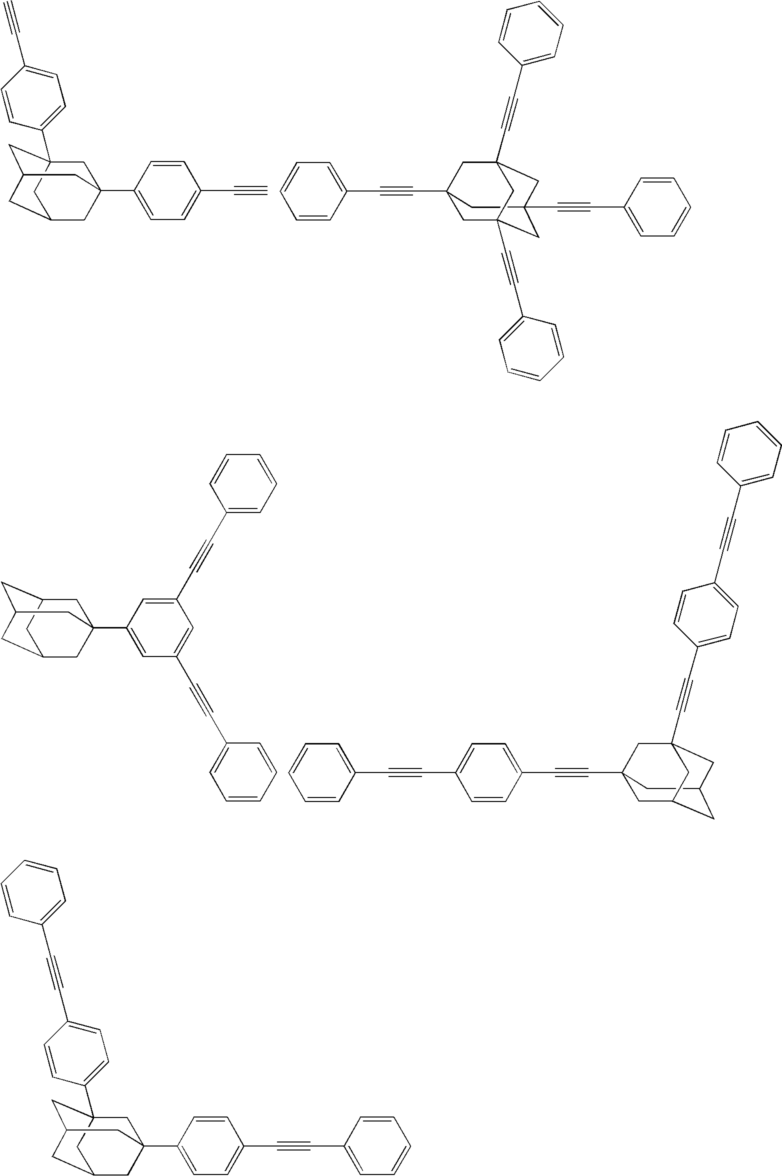

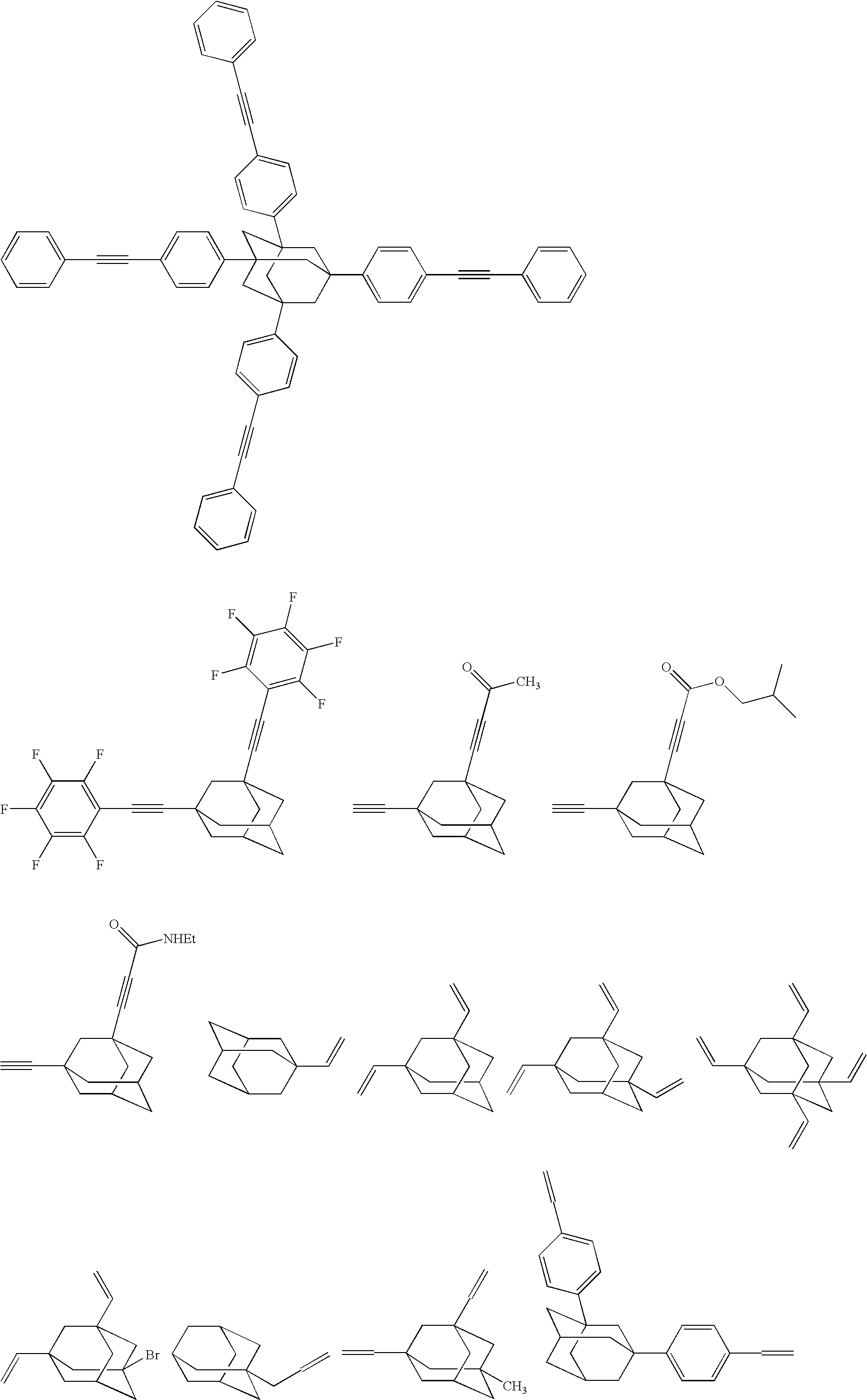

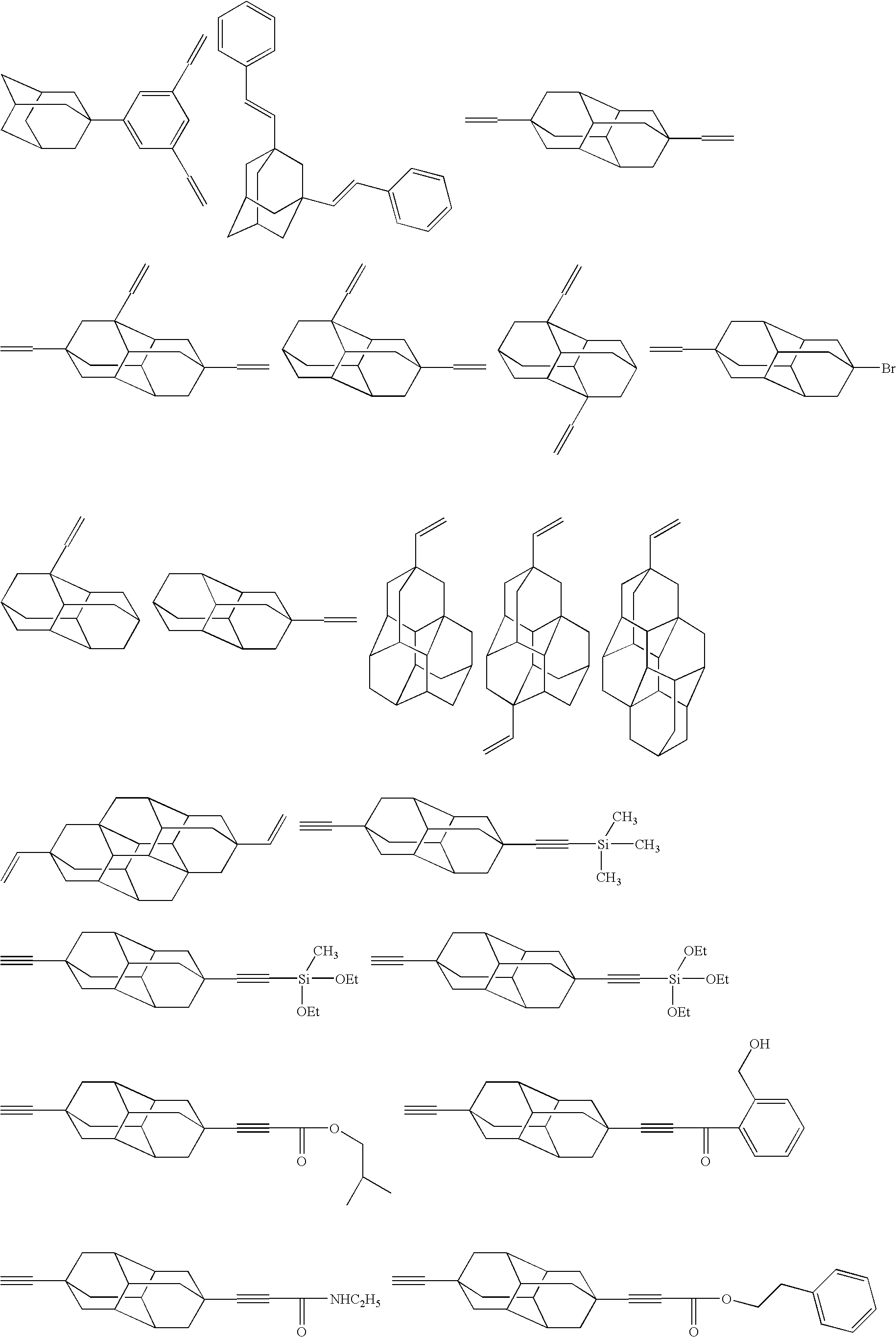

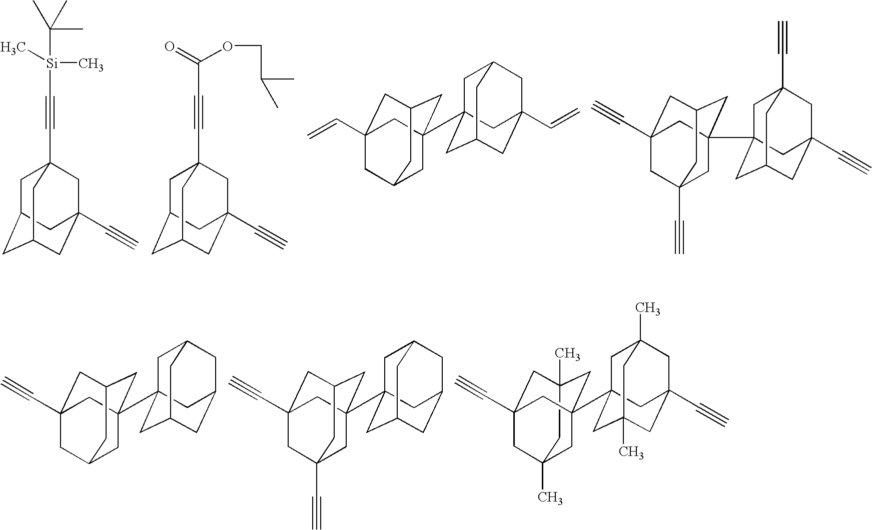

The compounds having a cage structure for use in the invention may be used either singly or in combination. They may be used in combination with a compound having no cage structure.

The compound having a cage structure for use in the invention may be a low molecular weight compound such as polymerizable monomer or a polymer of the monomer having a cage structure. The compound having a cage structure for use in the invention may be, for example, a copolymer of a monomer having a carbon-carbon triple bond or carbon-carbon double bond as a polymerizable group and having no cage structure (for example, a saturated hydrocarbon monomer or aromatic hydrocarbon monomer) and the monomer having a cage structure.

When the compound having a cage structure for use in the invention is a copolymer with a monomer having no cage structure, a molar ratio of the monomer having a cage structure is preferably from 1 to 99 mole %, more preferably from 40 to 95 mole %, especially preferably from 70 to 90 mole %.

In the invention, two different monomers having a cage structure can be copolymerized. The monomers have preferably at least two cage structures different from each other. A copolymer of two monomers having respectively different cage structures is more preferred.

Especially preferred combinations of cage structures from the viewpoints of low dielectric constant and high Young's modulus include combinations of adamantane and biadamantane, adamantane and diamantane, and biadamantane and diamantane. This means that combination of at least two cage structures different in steric bulkiness makes it possible to form fine and uniform voids in the polymer molecule and decrease the low dielectric constant of the polymer without impairing its mechanical strength.

Supposing that two monomers having respectively different two cage structures are A and B, the number of moles of A/(the number of moles of A+the number of moles of B) is preferably from 0.10 to 0.90, more preferably from 0.30 to 0.70, especially preferably from 0.40 to 0.60.

The monomer having a cage structure for use in the invention has a molecular weight of preferably from 160 to 1500, more preferably from 160 to 1100, still more preferably from 160 to 800, especially preferably from 160 to 220.

The monomer having a cage structure for use in the invention is available, for example, by substituting a compound having a cage structure with a polymerizable group. The term “polymerizable group” as used herein means a reactive substituent for polymerizing the monomer. It can be synthesized, for example, by using easily available adamantane, biadamantane or diamantane as a raw material, reacting it with bromine in the presence or absence of an aluminum bromide catalyst to introduce a bromine atom into a desired position, causing a Friedel-Crafts reaction between the resulting compound with vinyl bromine in the presence of a Lewis acid such as aluminum bromide, aluminum chloride or iron chloride to introduce a 2,2-dibromoethyl group, and then converting it into an ethynyl group by the HBr elimination using a strong base. More specifically, it can be synthesized in accordance with the process as described in Macromolecules, 24, 5266-5268 (1991) and 28, 5554-5560 (1995), Journal of Organic Chemistry, 39, 2995-3003 (1974) and the like.

By reduction of the ethynyl group with diisobutylaluminum hydride, a vinyl derivative can easily obtained.

Alternatively, an alkyl group or silyl group can be introduced by making the hydrogen atom of the terminal acetylene group anionic by using butyl lithium or the like and then, reacting the resulting compound with an alkyl halide or silyl halide.

In the invention, the polymerization reaction of monomers occurs by the polymerizable group substituted for the monomer. Polymerization reaction is not limited but examples of it include radical polymerization, cationic polymerization, anionic polymerization, ring-opening polymerization, polycondensation, polyaddition, addition condensation and polymerization in the presence of a transition metal catalyst.

The polymerization reaction of the monomer in the invention is preferably carried out in the presence of a non-metallic polymerization initiator. For example, a monomer having a polymerizable carbon-carbon double bond or carbon-carbon triple bond can be polymerized in the presence of a polymerization initiator showing activity while generating free radicals such as carbon radicals or oxygen radicals by heating.

The polymerization initiator usable in the invention preferably shows activity while generating free radicals such as carbon radicals or oxygen radicals by heating. Organic peroxides or organic azo compounds are especially preferred.

Preferred examples of the organic peroxides include ketone peroxides such as “PERHEXA H”, peroxyketals such as “PERHEXA TMH”, hydroperoxides such as “PERBUTYL H-69”, dialkylperoxides such as “PERCUMYL D”, “PERBUTYL C” and “PERBUTYL D”, diacyl peroxides such as “NYPER BW”, peroxy esters such as “PERBUTYL Z” and “PERBUTYL L”, and peroxy dicarbonates such as “PEROYL TCP”, (each, trade name; commercially available from NOF Corporation), diisobutyryl peroxide, cumylperoxyneodecanoate, di-n-propylperoxydicarbonate, diisopropylperoxydicarbonate, di-sec-butylperoxydicarbonate, 1,1,3,3-etramethylbutylperoxyneodecanoate, di(4-t-butylchlorohexyl)peroxydicarbonate, di(2-ethylhexyl)peroxydicarbonate, t-hexylperoxyneodecanoate, t-butylperoxyneodecanoate, t-butylperoxyneoheptanoate, t-hexylperoxypivalate, t-butylperoxypivalate, di(3,5,5-trimethylhexanoyl)peroxide, dilauroyl peroxide, 1,1,3,3-tetramethylbutylperoxy-2-ethylhexanoate, disuccinic acid peroxide, 2,5-dimethyl-2,5-di(2-ethylhexanoylperoxy)hexane, t-hexylperoxy-2-ethylhexanoate, di(4-methylbenzoyl)peroxide, t-butylperoxy-2-ethylhexanoate, di(3-methylbenzoyl)peroxide, benzoyl(3-methylbenzoyl) peroxide, dibenzoyl peroxide, 1,1-di(t-butylperoxy)-2-methylcyclohexane, 1,1-di(t-hexylperoxy)-3,3,5-trimethylcyclohexane, 1,1-di(t-hexylperoxy)cyclohexane, 1,1-di(t-butylperoxy)cyclohexane, 2,2-di(4,4-di-(t-butylperoxy)cyclohexyl)propane, t-hexylperoxyisopropyl monocarbonate, t-butylperoxymaleic acid, t-butylperoxy-3,5,5-trimethylhexanoate, t-butyolperoxylaurate, t-butylperoxyisopropylmonocarbonate, t-butylperoxy-2-ethylhexylmonocarbonate, t-hexylperoxybenzoate, 2,5-dimethyl-2,5-di(benzoylperoxy)hexane, t-butylperoxyacetate, 2,2-di-(t-butylperoxy)butane, t-butylperoxybenzoate, n-butyl-4,4-di-t-butylperoxyvalerate, di(2-t-butylperoxyisopropyl)benzene, dicumyl peroxide, di-t-hexyl peroxide, 2,5-dimethyl-2,5-di(t-butylperoxy)hexane, t-butylcumyl peroxide, di-t-butyl peroxide, p-methane hydroperoxide, 2,5-dimethyl-2,5-di(t-butylperoxy)hexine-3, diisopropylbenzene hydroperoxide, 1,1,3,3-tetramethylbutyl hydroperoxide, cumene hydroperoxide, t-butyl hydroperoxide, 2,3-dimethyl-2,3-diphenylbutane, 2,4-dichlorobenzoyl peroxide, o-chlorobenzoyl peroxide, p-chlorobenzoyl peroxide, tris-(t-butylperoxy)triazine, 2,4,4-trimethylpentylperoxyneodecanoate, α-cumylperoxyneodecanoate, t-amylperoxy-2-ethylhexanoate, t-butylperoxyisobutyrate, di-t-butylperoxyhexahydroterephthalate, di-t-butylperoxytrimethyladipate, di-3-methoxybutylperoxydicarbonate, di-isopropylperoxydicarbonate, t-butylperoxyisopropylcarbonate, 1,6-bis(t-butylperoxycarbonyloxy)hexane, diethylene glycol bis(t-butylperoxycarbonate) and t-hexylperoxyneodecanoate.

Examples of the organic azo compound include azonitrile compounds such as “V-30”, “V-40”, “V-59”, “V-60”, “V-65” and “V-70”, azoamide compounds such as “VA-080”, “VA-085”, “VA-086”, “VF-096”, “VAm-110” and “VAm-111”, cyclic azoamidine compounds such as “VA-044” and “VA-061”, and azoamidine compounds such as “V-50” and VA-057” (each, trade name; commercially available from Wako Pure Chemical Industries), 2,2-azobis(4-methoxy-2,4-dimethylvaleronitrile), 2,2-azobis(2,4-dimethylvaleronitrile), 2,2-azobis(2-methylpropionitrile), 2,2-azobis(2,4-dimethylbutyronitrile), 1,1-azobis(cyclohexane-1-carbonitrile), 1-[(1-cyano-1-methylethyl)azo]formamide, 2,2-azobis{2-methyl-N-[1,1-bis(hydroxymethyl)-2-hydroxyethyl]propionamide}, 2,2-azobis[2-methyl-N-(2-hydroxybutyl)propionamide], 2,2-azobis[N-(2-propenyl)-2-methylpropionamide], 2,2-azobis(N-butyl-2-methylpropionamide), 2,2-azobis(N-cyclohexyl-2-methylpropionamide), 2,2-azobis[2-(2-imidazolin-2-yl)propane]dihydrochloride, 2,2-azobis[2-(2-imidazolin-2-yl)propane]disulfate dihydrate, 2,2-azobis{2-[1-(2-hydroxyethyl)-2-imidazolin-2-yl]propane}dihydrochloride, 2,2-azobis[2-[2-imidazolin-2-yl]propane], 2,2-azobis(1-imino-1-pyrrolidino-2-methylpropane)dihydrochloride, 2,2-azobis(2-methylpropionamidine)dihydrochloride, 2,2-azobis[N-(2-carboxyethyl)-2-methylpropionamidine]tetrahydrate, dimethyl-2,2-azobis(2-methylpropionate), 4,4-azobis(4-cyanovaleric acid) and 2,2-azobis(2,4,4-trimethylpentane).

In the invention, these polymerization initiators may be used either singly or in combination.

The amount of the polymerization initiator in the invention is preferably from 0.001 to 2 moles, more preferably from 0.01 to 1 mole, especially preferably from 0.05 to 0.5 mole, per mole of the monomer.

In the invention, the polymerization reaction of a monomer may be effected in the presence of a transition metal catalyst. For example, it is preferred to carry out polymerization of a monomer having a polymerizable carbon-carbon double bond or carbon-carbon triple bond, for example, in the presence of a Pd catalyst such as Pd(PPh₃)₄ or Pd(OAc)₂, a Ziegler-Natta catalyst, an Ni catalyst such as nickel acetyl acetonate, a W catalyst such as WCl₆, an Mo catalyst such as MoCl₅, a Ta catalyst such as TaCl₅, an Nb catalyst such as NbCl₅, an Rh catalyst or a Pt catalyst.

In the invention, these transition metal catalysts may be used either singly or in combination.

In the invention, the amount of the transition metal catalyst is preferably from 0.001 to 2 moles, more preferably from 0.01 to 1 mole, especially preferably from 0.05 to 0.5 mole per mole of the monomer.

The polymerization initiator is preferably the above-described radical initiator.

As the solvent to be used for polymerization reaction, any solvent capable of dissolving therein a raw material monomer having a necessary concentration and having no adverse effects on the properties of a film formed from the resulting polymer can be used. Examples include water; alcohol solvents such as methanol, ethanol and propanol; ketone solvents such as alcohol acetone, methyl ethyl ketone, methyl isobutyl ketone, cyclohexanone and acetophenone; ester solvents such as ethyl acetate, butyl acetate, propylene glycol monomethyl ether acetate, γ-butyrolactone, and methyl benzoate; ether solvents such as dibutyl ether and anisole; aromatic hydrocarbon solvents such as toluene, xylene, mesitylene and 1,3,5-triisopropylbenzene; amide solvents such as N-methylpyrrolidinone and dimethylacetamide; and aliphatic hydrocarbon solvents such as hexane, heptane, octane and cyclohexane. Of these, more preferred are acetone, methyl ethyl ketone, methyl isobutyl ketone, cyclohexanone, acetophenone, ethyl acetate, propylene glycol monomethyl ether acetate, γ-butyrolactone, anisole, tetrahydrofuran, toluene, xylene, mesitylene, 1,3,5-triisopropylbenzene, and t-butylbenzene, of which tetrahydrofuran, γ-butyrolactone, anisole, toluene, xylene, mesitylene, 1,3,5-triisopropylbenzene, and t-butylbenzene, with γ-butyrolactone, anisole, mesitylene, 1,3,5-triisopropylbenzene, and t-butylbenzene being especially preferred. These solvents may be used either singly or in combination.

The concentration of the monomer in the reaction mixture is preferably from 1 to 50 mass %, more preferably from 5 to 30 mass %, especially preferably from 10 to 20 mass %.

The optimum conditions for the polymerization reaction in the invention differ, depending on the kind or concentration of the polymerization initiator, monomer or solvent. The internal temperature is preferably from 0 to 200° C., more preferably from 50 to 170° C., especially preferably from 100 to 150° C., while the reaction time is preferably from 1 to 50 hours, more preferably from 2 to 20 hours, especially preferably from 3 to 10 hours.

In order to suppress the inactivation of the polymerization initiator due to oxygen, the reaction is performed preferably in an inert gas atmosphere (such as nitrogen or argon). The oxygen concentration during the reaction is preferably 100 ppm or less, more preferably 50 ppm or less, especially preferably 20 ppm or less.

The copolymer to be used in the invention has a weight average molecular weight of preferably from 1000 to 500000, more preferably from 5000 to 200000, especially preferably from 10000 to 100000. The copolymer of the invention may be contained in a film forming composition as a resin composition having a molecular weigh distribution.

The concentration of the copolymer in the film forming composition of the invention is preferably from 10 to 100 mass %, more preferably from 50 to 100 mass %, still more preferably from 90 to 100 mass %.

### [2] Thermally Decomposable Compound

A thermally decomposable compound is added to the film forming composition of the invention. It has been found that the thermally decomposable compound incorporated in the film forming composition exhibits an unexpected excellent effect in suppressing a time-dependent change in the dielectric constant of the composition which will otherwise occur by the moisture absorption. It has also been found that the compound can reduce the dielectric constant.

The thermally decomposable compound usable in the invention has such a property that 50% or greater of its weight decomposes and evaporates when it is heated for from 30 to 90 minutes preferably at from 50 to 450° C., more preferably from 100 to 420° C., especially preferably from 200 to 400° C. This property is preferred, because the compound shows this property at 50° C. or greater, which enables suppression of sublimation or evaporation at the time of drying a solvent and promotes formation of voids; and because the compound shows this property at 450° C. or less, which suppresses remaining of undecomposed substances in a cured film and tends to improve the properties of the film.

The thermally decomposable compound is preferably at least one compound selected from compounds having a structure represented by any one of the following formulas (A-1) to (A-3), and compounds having a composite structure of the following formulas (A-2) and (A-3).

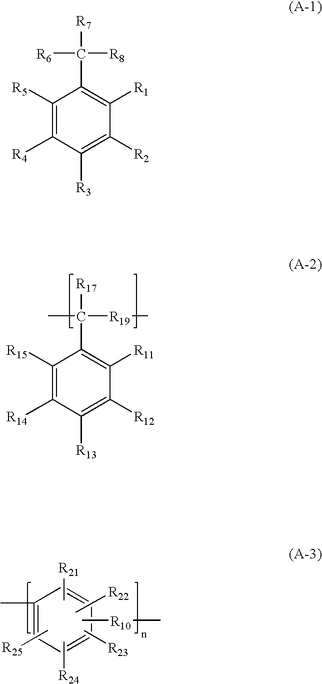

In the above formulas (A-1) to (A-3), R₁ to R₆, R₈, R₁₁ to R₁₅, and R₂₁ to R₂₅ each independently represents a hydrogen atom or a hydrocarbon group (such as methyl, ethyl, propyl, butyl, hexyl, t-butyl, vinyl, allyl, 2-buten-1-yl, ethynyl, propargyl, phenyl or p-tolyl), preferably a hydrogen atom or C₁₋₁₂ hydrocarbon group, more preferably hydrogen atom or C₁₋₄ hydrocarbon group.

R₇ and R₁₇ each represents an oxygen-atom-containing hydrocarbon group, preferably a C₁₋₁₂ hydrocarbon group containing 2 to 4 oxygen atoms, more preferably C₁₋₁₂ hydrocarbon group containing 2 oxygen atoms. Examples of the oxygen-containing hydrocarbon group include the hydrocarbon groups exemplified as R₁ which have been linked via —O— or —OO—, and the hydrocarbon groups exemplified as R₁ having —O— or —OO— at any possible position therein.

R₁₉ and R₁₀ each represents an alkylene group, preferably —CR₄₁—, in which R₄₁ represents a hydrogen atom or a C₁₋₁₂ alkyl group (such as methyl, ethyl, propyl, butyl, hexyl or t-butyl), preferably a hydrogen atom or a C₁₋₄ alkyl group, more preferably a hydrogen atom.

R₁₀ represents an alkylene group, preferably —CHR₄₂—CHR₄₃—, in which R₄₂ and R₄₃ each independently represents a hydrogen atom or a C₁₋₁₂ allyl group (such as methyl, ethyl, propyl, butyl, hexyl, or t-butyl), preferably a hydrogen atom or C₁₋₄ alkyl group, more preferably a hydrogen atom.

The compound (A-1) is preferably an organic peroxide.

Specific examples of the thermally decomposable compound usable in the invention include dicumyl peroxide, t-butylcumyl peroxide, cumylperoxyneodecanoate, di(2-t-butylperoxyisopropyl)benzene, α-methylstyrene dimer, 2,3-dimethyl-2,3-diphenylbutane, styrene dimer, polystyrene, polydivinylbenzene, polystyrene-polydivinylbenzene copolymer, polytrivinylbenzene, polydiethynylbenzene, polytriethynylbenzene, poly-α-methylstyrene, polystyrene-poly-α-methylstyrene copolymer, polystyrene-poly-4-methylstyrene copolymer, poly-4-methylstyrene, poly(4-t-butylstyrene), poly(2-vinylnaphthalene), bibenzyl, paracyclophane, triphenylmethane, 1,2,4,5-tetrabenzylbenzene, 3-(4-t-butylphenyl)-1,2,4,5-tetraphenyl-1,5-pentanedione, and octaphenylcyclobutane.

Particularly, specific examples of the compound having a composite structure of the formulas (A-2) and (A-3) include polystyrene-polydivinylbenzene copolymer, poly-α-methylstyrene-polydivinylbenzene copolymer, poly-4-methylstyrene-polydivinylbenzene copolymer, polystyrene-polytrivinylbenzene copolymer, and polystyrene-polydiethynylbenzene copolymer.

The thermally decomposable compound has a weight average molecular weight (Nw) of preferably from 200 to 50000, more preferably from 200 to 30000, especially preferably from 300 to 20000. When the molecular weight is 200 or greater, evaporation or sublimation at the stage of drying a solvent can be suppressed, which facilitates formation of voids. When it is not greater than 50000, troubles such as worsening of filtration property and worsening of solubility in a solvent can be prevented. The weight average molecular weights within the above-described range are therefore preferred.

The thermally decomposable compounds of the invention may be used either single or in combination.

The amount of the thermally decomposable compound of the invention is preferably from 0.1 to 200 parts by mass, more preferably from 0.5 to 150 parts by mass, especially preferably from 1 to 100 parts by mass based on 100 parts by mass of the cage compound.

### [3] Film Forming Composition

The film forming composition of the invention contains the compound may contain a solvent and can be used as a coating solution.

Although no particular limitation is imposed on the coating solvent to be used in the invention, examples include alcohol solvents such as methanol, ethanol, 2-propanol, 1-butanol, 2-ethoxymethanol, 3-methoxypropanol and 1-methoxy-2-propanol; ketone solvents such as acetone, acetylacetone, methyl ethyl ketone, methyl isobutyl ketone, 2-pentanone, 3-pentanone, 2-heptanone, 3-heptanone, cyclopentanone and cyclohexanone; ester solvents such as ethyl acetate, propyl acetate, butyl acetate, isobutyl acetate, pentyl acetate, ethyl propionate, propyl propionate, butyl propionate, isobutyl propionate, propylene glycol monomethyl ether acetate, methyl lactate, ethyl lactate and γ-butyrolactone; ether solvents such as diisopropyl ether, dibutyl ether, ethyl propyl ether, anisole, phenetole and veratrole; aromatic hydrocarbon solvents such as mesitylene, ethylbenzene, diethylbenzene, propylbenzene and t-butylbenzene; and amide solvents such as N-methylpyrrolidinone and dimethylacetamide. These solvents may be used either singly or in combination.

Of these, more preferred are 1-methoxy-2-propanol, propanol, acetylacetone, cyclohexanone, propylene glycol monomethyl ether acetate, butyl acetate, methyl lactate, ethyl lactate, γ-butyrolactone, anisole, mesitylene, and t-butylbenzene, with 1-methoxy-2-propanol, cyclohexanone, propylene glycol monomethyl ether acetate, ethyl lactate, γ-butyrolactone, t-butylbenzene and anisole being especially preferred.

The solid concentration of the film forming composition of the invention is preferably from 1 to 50 mass %, more preferably from 2 to 15 mass %, especially preferably from 3 to 10 mass %.

The compound having a cage structure for use in the invention preferably has a higher solubility in a solvent from the viewpoint of preventing precipitation of insoluble matters with the passage of storage time of the film forming composition. Its solubility at 25° C. is preferably 3 mass % or greater, more preferably 5 mass % or greater, especially preferably 10 mass % or greater in cyclohexanone or anisole.

The content of metals, as an impurity, of the film forming composition of the invention is preferably as small as possible. The metal content of the film forming composition can be measured with high sensitivity by the ICP-MS and in this case, the content of metals other than transition metals is preferably 30 ppm or less, more preferably 3 ppm or less, especially preferably 300 ppb or less. The content of the transition metal is preferably as small as possible because it accelerates oxidation by its high catalytic capacity and the oxidation reaction in the prebaking or thermosetting process decreases the dielectric constant of the film obtained by the invention. Its content is preferably 10 ppm or less, more preferably 1 ppm or less, especially preferably 100 ppb or less.

The metal concentration of the film forming composition can also be evaluated by subjecting a film obtained using the film forming composition of the invention to total reflection fluorescent X-ray analysis.

When W ray is employed as an X-ray source, K, Ca, Ti, Cr, Mn, Fe, Co, Ni, Cu, Zn, and Pd can be measured as metal elements. The concentrations of them are each preferably from 100×10¹⁰ atom·cm⁻² or less, more preferably 50×10¹⁰ atom·cm⁻² or less, especially preferably 10×10¹⁰ atom·cm⁻² or less.

In addition, the concentration of Br as a halogen can be measured. Its remaining amount is preferably 10000×10¹⁰ atom·cm⁻² or less, more preferably 1000×10¹⁰ atom·cm², especially preferably 400×10¹⁰ atom·cm⁻².

Moreover, the concentration of Cl can also be observed as a halogen. In order to prevent it from damaging a CVD device, etching device or the like, its remaining amount is preferably 100×10¹⁰ atom·cm⁻² or less, more preferably 50×10¹⁰ atom·cm⁻², especially preferably 10×10¹⁰ atom·cm⁻².

To the film forming composition of the invention, additives such as radical generator, colloidal silica, surfactant, silane coupling agent and adhesive agent may be added without impairing the properties (such as heat resistance, dielectric constant, mechanical strength, coatability, and adhesion) of the insulating film obtained using it.

Any colloidal silica may be used in the invention. For example, a dispersion obtained by dispersing high-purity silicic anhydride in a hydrophilic organic solvent or water and having usually an average particle size of from 5 to 30 nm, preferably from 10 to 20 nm and a solid concentration of from about 5 to 40 mass % can be used.

Any surfactant may be added in the invention. Examples include nonionic surfactants, anionic surfactants and cationic surfactants. Further examples include silicone surfactants, fluorosurfactants, polyalkylene oxide surfactants, and acrylic surfactants. In the invention, these surfactants can be used either singly or in combination. As the surfactant, silicone surfactants, nonionic surfactants, fluorosurfactants and acrylic surfactants are preferred, with silicone surfactants being especially preferred.

The amount of the surfactant to be used in the invention is preferably from 0.01 mass % or greater but not greater than 1 mass %, more preferably from 0.1 mass % or greater but not greater than 0.5 mass % based on the total amount of the film forming coating solution.

The term “silicone surfactant” as used herein means a surfactant containing at least one Si atom. Any silicone surfactant may be used in the invention, but it preferably contains a structure containing an alkylene oxide and dimethylsiloxane, of which a silicone surfactant containing a compound represented by the following chemical formula is more preferred:

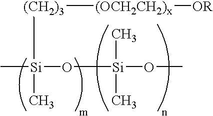

In the above formula, R represents a hydrogen atom or an alkyl group (preferably, C₁₋₅), x stands for an integer of from 1 to 20, and m and n each independently represents an integer of from 2 to 100. When a plurality of xs and Rs exist, they may be the same or different.

Examples of the silicone surfactant to be used in the invention include “BYK 306”, “BYK 307” (each, trade name; product of BYK Chemie), “SH7PA”, “SH21PA”, “SH28PA”, and “SH30PA” (each, trade name; product of Dow Corning Toray Silicone) and Troysol S366 (trade name; product of Troy Chemical).

As the nonionic surfactant to be used in the invention, any nonionic surfactant is usable. Examples include polyoxyethylene alkyl ethers, polyoxyethylene aryl ethers, polyoxyethylene dialkyl esters, sorbitan fatty acid esters, fatty-acid-modified polyoxyethylenes, and polyoxyethylene-polyoxypropylene block copolymers.

As the fluorosurfactant to be used in the invention, any fluorosurfactant is usable. Examples include perfluorooctyl polyethylene oxide, perfluorodecyl polyethylene oxide and perfluorododecyl polyethylene oxide.

As the acrylic surfactant to be used in the invention, any acrylic surfactant is usable. Examples include (meth)acrylic acid copolymer.

Any silane coupling agent may be used in the invention. Examples include 3-glycidyloxypropyltrimethoxysilane, 3-aminoglycidyloxypropyltriethoxysilane, 3-methacryloxypropyltrimethoxysilane, 3-glycidyloxypropylmethyldimethoxysilane, 1-methacryloxypropylmethyldimethoxysilane, 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-triethoxysilylpropyltriethylenetriamine, 10-trimethoxysilyl-1,4,7-triazadecane, 10-triethoxysilyl-1,4,7-triazadecane, 9-trimethoxysilyl-3,6-diazanonyl acetate, 9-triethoxysilyl-3,6-diazanonyl acetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, and N-bis(oxyethylene)-3-aminopropyltriethoxysilane. Those silane coupling agents may be used either singly or in combination.

In the invention, any adhesion accelerator may be used. Examples include trimethoxysilylbenzoic acid, γ-methacryloxypropyltrimethoxysilane, vinyltriacetoxysilane, vinyltrimethoxysilane, γ-isocyanatopropyltriethoxysilane, γ-glycidoxypropyltrimethoxysilane, β-(3,4-epoxycyclohexyl)ethyltrimethoxysilane, trimethoxyvinylsilane, γ-aminopropyltriethoxysilane, aluminum monoethylacetoacetate disopropylate, vinyltris(2-methoxyethoxy)silane, N-(2-aminoethyl)-3-aminopropylmethyldimethoxysilane, N-(2-aminoethyl)-3-aminopropyltrimethoxysilane, 3-methacryloxypropyltrimethoxysialne, 3-mercaptopropyltrimethoxysilane, trimethylmethoxysilane, dimethyldiethoxysilane, methyldimethoxysilane, dimethylvinylethoxysilane, diphenyldimethoxysilane, phenyltriethoxysilane, hexamethyldisilazane, N,N′-bis(trimethylsilyl)urea, dimethyltrimethylsilylamine, trimethylsilylimidazole, benzotriazole, benzimidazole, indazole, imidazole, 2-mercaptobenzimidazole, 2-mercaptobenzothiazole, 2-mercaptobenzoxazole, urazole, thiourasil, mercaptoimidazole, mercaptopyrimidine, 1,1-dimethylurea, 1,3-dimethylurea and thiourea compounds. A functional silane coupling agent is preferred as an adhesion accelerator.

The amount of the adhesion accelerator is preferably 10 parts by mass or less, especially preferably from 0.05 to 5 parts by mass, based on 100 parts by mass of the total solid content.

The film can be formed by applying the film forming composition of the invention onto a substrate by a desired method such as spin coating, roller coating, dip coating or scan coating, and then heating to remove the solvent and dry the film. As the method of applying the composition to the substrate, spin coating and scan coating are preferred, with spin coating being especially preferred. For spin coating, commercially available apparatuses such as “Clean Track Series” (trade name; product of Tokyo Electron), “D-spin Series” (trade name; product of Dainippon Screen), or “SS series” or “CS series” (each, trade name; product of Tokyo Oka Kogyo) are preferably employed. The spin coating may be performed at any rotation speed, but from the viewpoint of in-plane uniformity of the film, a rotation speed of about 1300 rpm is preferred for a 300-mm silicon substrate.

When the solution of the composition is discharged, either dynamic discharge in which the solution is discharged onto a rotating substrate or static discharge in which the solution is discharged onto a static substrate may be employed. The dynamic discharge is however preferred in view of the in-plane uniformity of the film. Alternatively, from the viewpoint of reducing the consumption amount of the composition, a method of discharging only a main solvent of the composition to a substrate in advance to form a liquid film and then discharging the composition thereon can be employed. Although no particular limitation is imposed on the spin coating time, it is preferably within 180 seconds from the viewpoint of throughput. From the viewpoint of the transport of the substrate, it is preferred to subject the substrate to processing (such as edge rinse or back rinse) for preventing the film from remaining at the edge portion of the substrate. The heat treatment method is not particularly limited, but ordinarily employed methods such as hot plate heating, heating with a furnace, heating in an RTP (Rapid Thermal Processor) to expose the substrate to light of, for example, a xenon lamp can be employed. Of these, hot plate heating or heating with a furnace is preferred. As the hot plate, a commercially available one, for example, “Clean Track Series” (trade name; product of Tokyo Electron), “D-spin Series” (trade name; product of Dainippon Screen) and “SS series” or “CS series” (trade name; product of Tokyo Oka Kogyo) is preferred, while as the furnace, “a series” (trade name; product of Tokyo Electron) is preferred.

It is especially preferred to apply the polymer of the invention onto a substrate and then heating to cure (bake) it. For this purpose, the polymerization reaction of a carbon triple bond remaining in the polymer at the time of post heating may be utilized. The post heat treatment is performed preferably at from 100 to 450° C., more preferably at from 200 to 420° C., especially preferably at from 350 to 400° C., preferably for from 1 minute to 2 hours, more preferably for from 10 minutes to 1.5 hours, especially preferably for from 30 minutes to 1 hour. The post heat treatment may be performed in several times. This post heat treatment is performed especially preferably in a nitrogen atmosphere in order to prevent thermal oxidation due to oxygen.

In the invention, the polymer may be cured (baked) not by heat treatment but by exposure to high energy radiation to cause polymerization reaction of a carbon triple bond remaining in the polymer. Examples of the high energy radiation include electron beam, ultraviolet ray and X ray. The curing (baking) method is not particularly limited to these methods.

When electron beam is employed as high energy radiation, the energy is preferably 50 keV or less, more preferably 30 keV or less, especially preferably 20 keV or less. Total dose of electron beam is preferably 5 μC/cm² or less, more preferably 2° C./cm² or less, especially preferably 1 μC/cm² or less. The substrate temperature when it is exposed to electron beam is preferably from 0 to 450° C., more preferably from 0 to 400° C., especially preferably from 0 to 350° C. Pressure is preferably from 0 to 133 kPa, more preferably from 0 to 60 kPa, especially preferably from 0 to 20 kPa. The atmosphere around the substrate is preferably an atmosphere of an inert gas such as Ar, He or nitrogen from the viewpoint of preventing oxidation of the polymer of the invention. An oxygen, hydrocarbon or ammonia gas may be added for the purpose of causing reaction with plasma, electromagnetic wave or chemical species which is generated by the interaction with electron beam. In the invention, exposure to electron beam may be carried out in plural times. In this case, the exposure to electron beam is not necessarily carried out under the same conditions but the conditions may be changed every time.

Ultraviolet ray may be employed as high energy radiation. The radiation wavelength range of the ultraviolet ray is preferably from 190 to 400 nm, while its output immediately above the substrate is preferably from 0.1 to 2000 mWcm⁻². The substrate temperature upon exposure to ultraviolet ray is preferably from 250 to 450° C., more preferably from 250 to 400° C., especially preferably from 250 to 350° C. The atmosphere around the substrate is preferably an atmosphere of an inert gas such as Ar, He or nitrogen from the viewpoint of preventing oxidation of the polymer of the invention. The pressure at this time is preferably from 0 to 133 kPa.

When the film obtained using the film forming composition of the invention is used as an interlayer insulating film for semiconductor, a barrier layer for preventing metal migration may be disposed on the side of an interconnect. In addition, a cap layer, an interlayer adhesion layer or etching stopping layer may be disposed on the upper or bottom surface of the interconnect or interlayer insulating film to prevent exfoliation at the time of CMP (Chemical Mechanical Polishing). Moreover, an interlayer insulating film made of another material may be disposed as needed to form plural layers.

The film obtained using the film forming composition of the invention can be etched for copper interconnection or another purpose. Either wet etching or dry etching can be employed, but dry etching is preferred. For dry etching, either ammonia plasma or fluorocarbon plasma can be used as needed. For the plasma, not only Ar but also a gas such as oxygen, nitrogen, hydrogen or helium can be used. Etching may be followed by ashing for the purpose of removing a photoresist or the like used for etching. Moreover, the ashing residue may be removed by washing.

The film obtained using the film forming composition of the invention may be subjected to CMP for planarizing the copper plated portion after copper interconnection. As a CMP slurry (chemical solution), a commercially available one (for example, product of Fujimi Incorporated, Rodel Nitta, JSR or Hitachi Chemical) can be used as needed. As a CMT apparatus, a commercially available one (for example, product of Applied Material or Ebara Corporation) can be used as needed. After CMP, the film can be washed in order to remove the slurry residue.

The film available using the film forming composition of the invention can be used for various purposes. For example, it is suited as an insulating film for semiconductor devices such as LSI, system LSI, DRAM, SDRAM, RDRAM, and D-RDRAM, and for electronic parts such as multi-chip module multilayered wiring boards. More specifically, it is usable as an interlayer insulating film for semiconductor, etching stopper film, surface protective film, and buffer coat film and in addition, as a passivation film in LSI, α-ray blocking film, cover lay film in flexographic plates, overcoat film, cover coat for flexible copper-lined plates, solder-resist film, and liquid-crystal alignment film.

As another purpose, the film of the invention can be used as a conductive film after doping thereinto an electron donor or acceptor, thereby imparting it with conductivity.

### EXAMPLES

The present invention will next be described by the following Examples, but the scope of it is not limited by them.

### Example 1

In accordance with the synthesis process as described in Macromolecules., 5266(1991), 4,9-diethynyldiamantane was synthesized. Next, 2 g of 4,9-diethynyldiamantane and 0.4 g of dicumyl peroxide (“Percumyl D”, trade name; product of NOF) and 10 ml of orthodichlorobenzene were stirred for 5 hours at an internal temperature of 140° C. under a nitrogen gas stream and were thus polymerized. After cooling the reaction mixture to room temperature, 100 ml of methanol was added. The solid thus precipitated was collected by filtration and washed with methanol, whereby 1.0 g of Polymer (A) having a mass average molecular weight of about 14000 was obtained.

Polymer (A) had a solubility at 25° C. of 20 mass % or greater in cyclohexanone.

A coating solution was prepared by completely dissolving 0.9 g of Polymer (A) and 0.1 g of polystyrene having Mw of 2500 in 10 g of cyclohexanone. The resulting solution was filtered through a 0.1-μm filter made of PTFE, followed by spin-coating onto a silicon wafer. The coating was heated at 250° C. for 60 seconds on a hot plate under a nitrogen gas stream and then baked for 60 minutes in a nitrogen-purged oven of 400° C. As a result, a 0.5-μm thick uniform film without spitting was obtained. The dielectric constant of the resulting film was calculated from the capacitance value thereof measured at 1 MHz by using a mercury probe manufactured by Four Dimensions and “HP4285A

### LCR meter (trade name)” manufactured by Yokogawa Hewlett Packard, resulting in 2.33. An increase in the dielectric constant was 0.02 when the film was stored for 1 week at a temperature of 23° C. and humidity of 45%.

### Example 2

In accordance with the process as described in a document (Journal of Polymer Science: Part A: Polymer Chemistry, 30, 1747-1754 (1992)), 3,3′-diethynyl-1,1′-biadamantane was synthesized. In a similar manner to Example 1 except for the use of 3,3′-diethynyl-1,1′-biadamantane instead of 4,9-diethynyldiamantane, a coating solution was prepared and a film was formed using it. As a result, a 0.5-μm thick uniform film without spitting was formed. The dielectric constant of the resulting film was calculated from the capacitance value thereof measured at 1 MHz by using a mercury probe manufactured by Four Dimensions and “HP4285A LCR meter (trade name)” manufactured by Yokogawa Hewlett Packard, resulting in 2.34. An increase in the dielectric constant was 0.02 when the film was stored for 1 week at a temperature of 23° C. and humidity of 45%.

### Example 3

In a similar manner to Example 1 except for the use of dicumyl peroxide instead of polystyrene having MW of 2500, a coating solution was prepared and a film was formed. As a result, a 0.5-μm thick uniform film without spitting was formed. The dielectric constant of the resulting film was calculated from the capacitance value thereof measured at 1 MHz by using a mercury probe manufactured by Four Dimensions and “HP4285A LCR meter (trade name)” manufactured by Yokogawa Hewlett Packard, resulting in 2.38. An increase in the dielectric constant was 0.03 when the film was stored for 1 week at a temperature of 23° C. and humidity of 45%.

### Referential Example 1

In accordance with the synthesis process as described in Macromolecules., 5266 (1991), 4,9-diethynyldiamantane was synthesized. Next, 2 g of 4,9-diethynyldiamantane, 0.4 g of dicumyl peroxide (“Percumyl D”, trade name; product of NOF) and 10 ml of orthodichlorobenzene were stirred for 5 hours at an internal temperature of 140° C. under a nitrogen gas stream and polymerized. After cooling the reaction mixture to room temperature, 100 ml of methanol was added. A solid thus precipitated was filtered and washed with methanol, whereby 1.0 g of Polymer (A) having a mass average molecular weight of about 14000 was obtained.

Polymer (A) had a solubility at 25° C. of 20 mass % or greater in cyclohexanone.

A coating solution was prepared by completely dissolving 1.0 g of Polymer (A) in 10 g of cyclohexanone. The resulting solution was filtered through a 0.1-μm filter made of PTFE, followed by spin-coating onto a silicon wafer. The coating was heated at 250° C. for 60 seconds on a hot plate under a nitrogen gas stream and then baked for 60 minutes in a nitrogen-purged oven of 400° C. As a result, a 0.5-μm thick uniform film without spitting was obtained. The dielectric constant of the resulting film was calculated from the capacitance value thereof measured at 1 MHz by using a mercury probe manufactured by Four Dimensions and “HP4285A LCR meter (trade name)” manufactured by Yokogawa Hewlett Packard, resulting in 2.42. An increase in the dielectric constant was 0.05 when the film was stored for 1 week at a temperature of 23° C. and humidity of 45%.

The compound contained in the film forming composition of the invention and having a cage structure is soluble in a coating solvent such as anisole or cyclohexanone. A film formed using the composition has a low dielectric constant and high mechanical strength. The film undergoes only a small change in dielectric constant even with the passage of time so that it is suited as an interlayer insulating film for electronic devices.

The entire disclosure of each and every foreign patent application from which the benefit of foreign priority has been claimed in the present application is incorporated herein by reference, as if fully set forth.

What is claimed is:

1. A film forming composition comprising;
a compound having a cage structure; and
a thermally decomposable compound.

2. The film forming composition according to claim 1,
wherein the thermally decomposable compound is at least one compound selected from compounds having a structure represented by any one of formulas (A-1) to (A-3) and compounds having a composite structure of formulas (A-2) and (A-3): 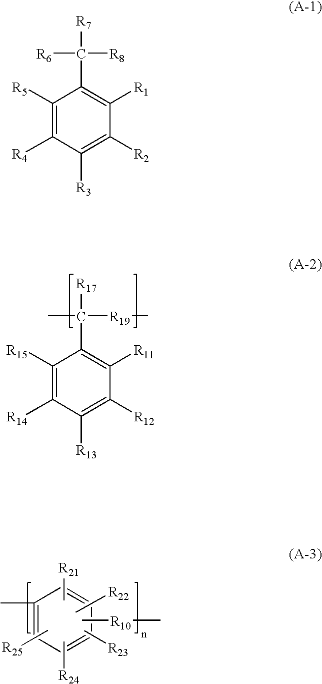
wherein R₁ to R₆, R₈, R₁₁ to R₁₅ and R₂₁ to R₂₅ each independently represents a hydrogen atom or a hydrocarbon group;
R₇ and R₁₇ each independently represents a hydrocarbon group containing an oxygen atom; and
R₁₉ and R₁₀ each independently represents an alkylene group.

3. The film forming composition according to claim 1,
wherein the cage structure is selected from adamantane, biadamantane, diamantane, triamantane, and tetramantane.

4. The film forming composition according to claim 1,
wherein the compound having the cage structure is a polymer of a monomer having a cage structure.

5. The film forming composition according to claim 4,
wherein the monomer having the cage structure has a carbon-carbon double bond or carbon-carbon triple bond.

6. The film forming composition according to claim 4,
wherein the monomer having the cage structure is selected from the group consisting of monomers represented by formulas (I) to (VI): 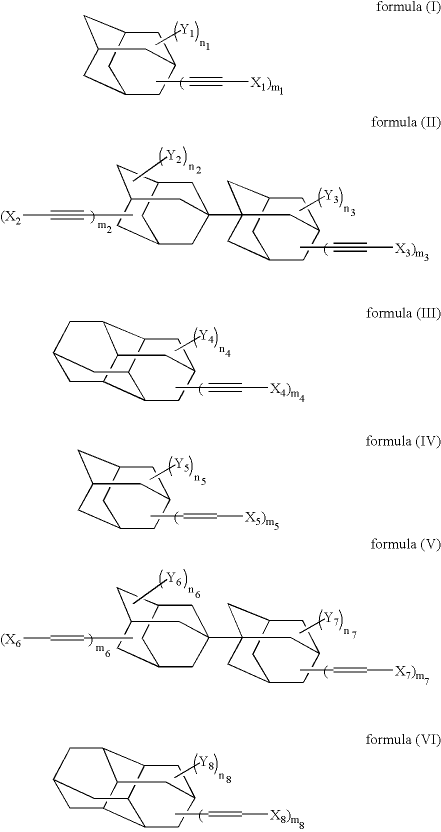
wherein X₁ to X₈ each independently represents a hydrogen atom, alkyl group, alkenyl group, alkynyl group, aryl group, silyl group, acyl group, alkoxycarbonyl group or carbamoyl group, and when a plurality of each of X₁s to X₈s are present, they may be the same or different;
Y₁ to Y₈ each independently represents a halogen atom, alkyl group, aryl group or silyl group, and when a plurality of each of Y₁s to Y₈s are present, they may be the same or different;
m₁ and m₅ each independently represents an integer of from 1 to 16;
n₁ and n₅ each independently represents an integer of from 0 to 15;
m₂, m₃, m₆ and m₇ each independently represents an integer of from 1 to 15;
n₂, n₃, n₆ and n₇ each independently represents an integer of from 0 to 14;
m₄ and m₈ each independently represents an integer of from 1 to 20; and
n₄ and n₈ each independently represents an integer of from 0 to 19.

7. The film forming composition according to claim 4, which is obtained by polymerizing the monomer having the cage structure in the presence of a transition metal catalyst or a radical initiator.

8. The film forming composition according to claim 1,
wherein the compound having the cage structure has a solubility of 3 mass % or greater in cyclohexanone or anisole at 25° C.

9. The film forming composition according to claim 1, further comprising an organic solvent.

10. An insulating film formed by using the film forming composition according to claim 1.

11. An electronic device comprising the insulating film according to claim 10.
